(19) United States
(12) Patent Application Publication
(10) Pub. No.: US 2009/0296966 A1
(43) Pub. Date: Dec. 3, 2009

(54) Hearing Kit

(76) Inventor: Yat Yiu Cheung, Hong Kong (HK)

Correspondence Address: OR, NG & CHAN, 15TH FLOOR, THE BANK OF EAST ASIA BUILDING, 10 DES VOEUX ROAD CENTRAL, HONG KONG, HK

(21) Appl. No.: 12/127,839

(22) Filed: May 28, 2008

(51) Int. Cl. H04R 25/00

(52) U.S. Cl. 381/313

(57) ABSTRACT

A hearing kit for use with a hearing device applying fixed beamforming technology, comprising a first end portion, a first microphone disposed at the first end portion, a second end portion, and a second microphone disposed at the second end portion. An elongated third portion is disposed between the first and second end portions for resting on the user's neck, adapted to position the first and second microphones on the left and right sides of the user at the same level. The first and second microphones are adapted to face outward toward the same direction in use. A processing unit is adapted to process signals received from the microphones and transmit processed signals to the hearing device. The microphones face toward the same direction of the user for receiving the listening sound.

### FIELD OF THE INVENTION

The present invention relates to a hearing kit, in particular, for use of fixed beamforming technology.

### BACKGROUND OF THE INVENTION

A hearing aid usually includes a microphone for receiving sound from the environment and converting sound into analog signal, an amplifier for amplifying the analog signal, and a speaker for converting the amplified signal into a louder sound. The disadvantage of the hearing aid is that the surrounding background noise will be amplified together with the sound to be listening to. In a noisy environment, it will be difficult for the user to distinguish the listening sound from the interfering background noise.

Beamforming is a technology for filtering the background noise and amplifying the listening sound so as to obtain a better Signal-to-Interference Ratio (SIR). A microphone is positioned on each of the left and right sides of the user directing to the listening sound for receiving the sound signals. A processor applies Generalized Sidelobe Cancellation (GSC) on the signals received from the two microphones. In the first stage of GSC, the delay-and-sum beamforming algorithm is applied to the two signals received from the two microphones to suppress the interference and to approximate a desired signal of the listening sound. In the second stage of GSC, a reference interfering signal is approximated by the delay-and-subtract version of the signals received from the two microphones. Least Mean Squared (LMS) adaptation algorithm is then applied to the delay-and-sum beamformed signal obtained from the first stage as the input noisy signal and the delay-and-subtract signal as the reference interference to further improve the SIR. Adaptive Noise Cancellation (ANC) algorithm is applied to suppress the background noise to obtain a better signal-to-noise ratio (SNR), so that the listening sound is more distinguishable to the user.

To achieve the above result, it is crucial that the two microphones are arranged on the left and right sides of the user, at a distance of 15 cm to 18 cm apart, and directing toward the listening sound. In the Hong Kong short-term patent publication no. HK 1101028 A as shown in FIG. 1, the microphones 81, 82 for receiving sound signals for the beamforming are attached to the hearing aid 85, 86 to maintain the appropriate distance between the microphones. As the socket on the hearing aid is a 3-pin socket, the microphone attached may not be facing the desired direction, and an additional device is disclosed in the application for adjusting the direction of the microphone, so that the microphones are facing the same direction. However, such direction adjusting device is costly to make as the device has to be relatively small. Attaching the microphones to the hearing aid also increases the weight to be borne by the user's ears and cause inconvenience to the user.

It is an objective of the present invention to provide a hearing kit for conveniently positioning the microphones on the user for use of fixed beamforming technology.

### SUMMARY OF THE INVENTION

The present invention includes a first end portion, a first microphone disposed at the first end portion, a second end portion, and a second microphone disposed at the second end portion. The invention further includes an elongated third portion disposed between the first and second end portions for resting on the user's neck, adapted to position the first and second microphones on the left and right sides of the user at the same level. The first and second microphones are adapted to face outward toward the same direction in use. A processing unit is adapted to process signals received from the microphones and transmit processed signals to the hearing device. The microphones face toward the same direction of the user for receiving the listening sound.

In one aspect of the invention, the third portion is bended.

In another aspect of the invention, the third portion is flexible.

In another aspect of the invention, the third portion is a cord.

In yet another aspect of the invention, the third portion of the embodiment is foldable for superimposing the first end portion with the second end portion.

In yet another aspect of the invention, the third portion of the embodiment includes a plurality of telescopic portions.

An advantage of the present invention is that the microphones for use of fixed beamforming technology can be conveniently positioned on the user. The microphones are positioned on the same level readily facing the same direction of the user for receiving the listening sound.

### BRIEF DESCRIPTION OF THE DRAWINGS

The above and other aspects, features, and advantages of the present invention will become more apparent upon consideration of the following detailed description of preferred embodiments, taken in conjunction with the accompanying figures, wherein:

FIG. 1 illustrates a hearing aid system applying beamforming technology of a published patent application.

FIG. 2a is a front view of an embodiment of this invention.

FIG. 2b is a back view of the hearing kit of FIG. 2a.

FIG. 3 is a perspective view of the hearing kit of FIG. 2a in use.

FIG. 4 is an illustrative view of a processing unit of FIG. 2a.

FIG. 5a is a perspective view of the hearing kit of FIG. 2a in a folded position.

FIG. 5b is a partial magnified view of FIG. 5a.

FIG. 6 is a perspective view of another embodiment of this invention.

FIG. 7 is a perspective view of another embodiment of this invention.

FIG. 8 is an illustrative view of another embodiment of this invention.

FIG. 9 is an illustrative view of another embodiment of this invention.

FIG. 10 is an illustrative view of another embodiment of this invention.

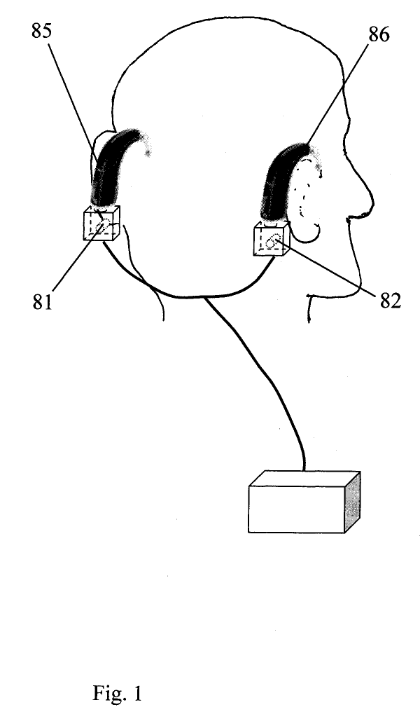

### DESCRIPTION OF A PREFERRED EMBODIMENT OF THE INVENTION

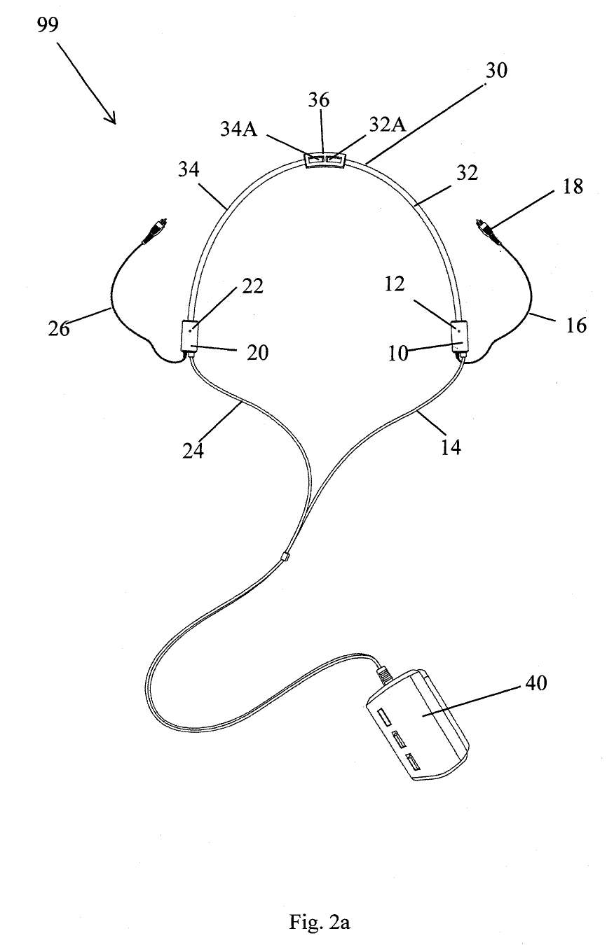

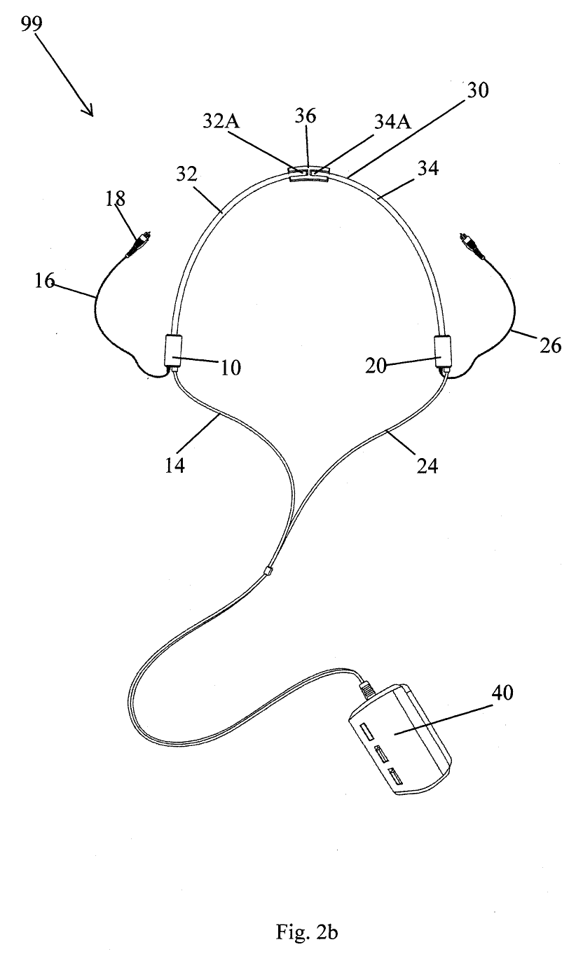

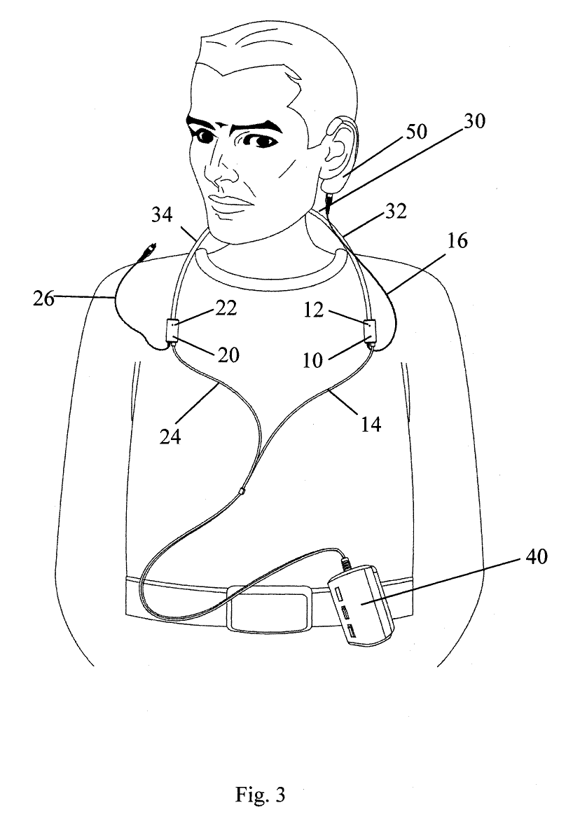

As shown in FIGS. 2a, 2b and 3, a preferred embodiment of the hearing kit 99 of the present invention includes a first end portion 10, a second end portion 20, and a third portion 30 between the first and second end portions 10, 20. A first microphone 12 is disposed on the first end portion and a second microphone 22 is disposed on the second end portion 20 for receiving the listening sound.

The third portion 30 is bended for resting on a user's neck such that the two microphones 12, 22 are positioned on the left and right sides of the user at the same level. The two microphones 12, 22 are arranged to face outward toward the same direction for receiving sound for beamforming. It is desirable that the microphones 12, 22 are directing to the listening sound to achieve the best beamforming result. In the embodiment, the microphones 12, 22 move with the user's body and are readily facing the front, which is the usual direction of the listening sound. The distance between the microphones 12, 22 are about 15 cm to 18 cm for achieving the best beamforming result. The third portion 30 may be flexible such that the distance between the microphones 12, 22 can be adjusted.

The connection means, for example, the first and second wires 14, 24 connect the microphones 12, 22 to a processing unit 40 to be carried by the user for applying the fixed beamforming technology to process the signals received from the microphones 12, 22.

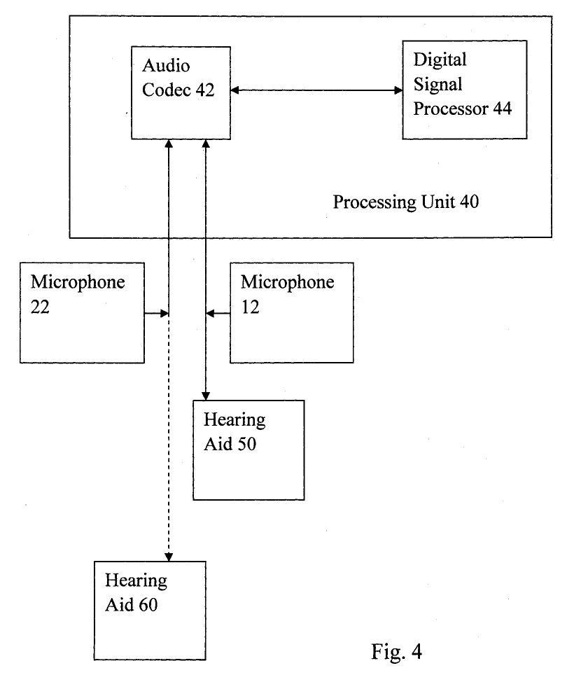

As shown in FIG. 4, the processing unit 40 includes an audio codec (coder-decoder) 42 for converting input analog signal to digital signal and processed digital signal to analog signal for output. The received signals are transmitted from the audio codec 42 to a digital signal processor 44 for the beamforming processing.

The digital signal processor 44 applies Generalized Sidelobe Cancellation (GSC) on the signals received from the two microphones 12, 22. In the first stage of GSC, the delay-and-sum beamforming algorithm is applied to the two signals received from the microphones 12, 22 to suppress the interference and to approximate a desired signal of the listening sound. In the second stage of GSC, a reference interfering signal is approximated by the delay-and-subtract version of the signals received from the two microphones 12, 22. Least Mean Squared (LMS) adaptation algorithm is then applied to the delay-and-sum beamformed signal obtained from the first stage as the input noisy signal and the delay-and-subtract signal as the reference interference to further improve the Signal-to-Interference Ratio (SIR).

The digital signal processor 44 also applies Adaptive Noise Cancellation (ANC) algorithm to suppress the background noise to obtain a better signal-to-noise ratio (SNR), so that the listening sound is more distinguishable to the user.

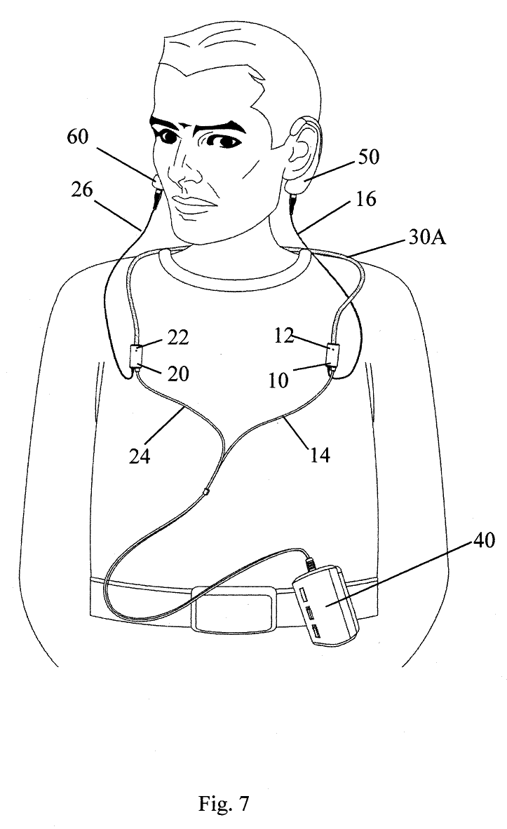

After processing by the digital signal processor 44, the processed signals are transmitted to the audio codec 42 for converting to analog signal. The converted analog signals are then transmitted to a hearing device. The hearing device is a device for converting the signal from the processing unit 40 to sound wave or vibration to be heard or sensed by the ear of the user. In this embodiment, the analog signals are transmitted to the hearing device, for example, a hearing aid 50 of the user through a third wire 16 with a connecting end 18 for connecting to the direct audio input (DAI) (not shown) of the hearing aid 50. If the user is using two hearing aids, there will be a fourth wire 26 for transmitting the converted audio signals to another hearing aid 60 as shown in FIG. 7.

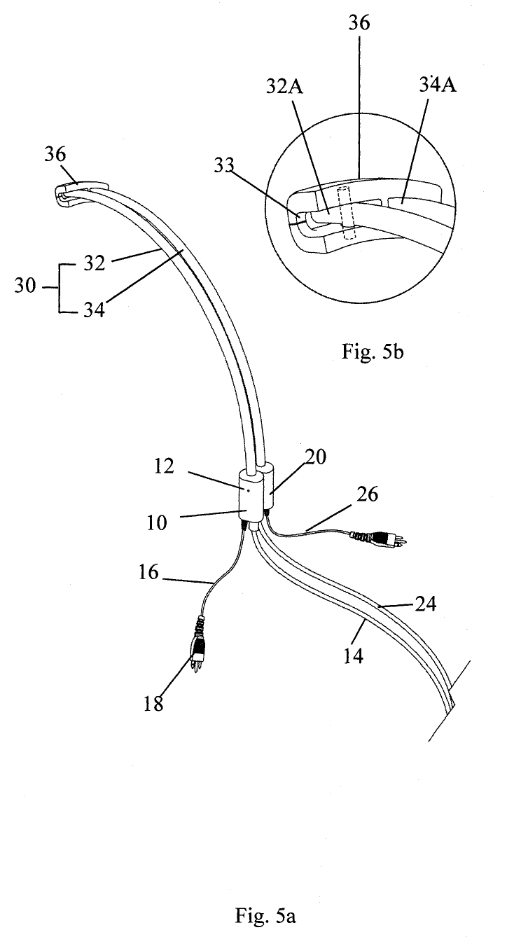

As shown in FIG. 5a, the third portion 30 is divided into two sub-portions 32, 34, being connected by a connecting member 36. The sub-portions 32, 34 have the ends 32A, 34A rotatable on the connecting member 36 so that the third portion 30 can be folded to superimpose the sub-portions 32, 34 together to reduce the size of the hearing kit 99.

As shown in FIG. 5b, the stopper 33 and another shopper (not shown) are formed on the connecting member 32 adjacent to the ends 32A, 34A of the sub-portions to restrict the rotation of the sub-portions 32, 34 to fold toward each other.

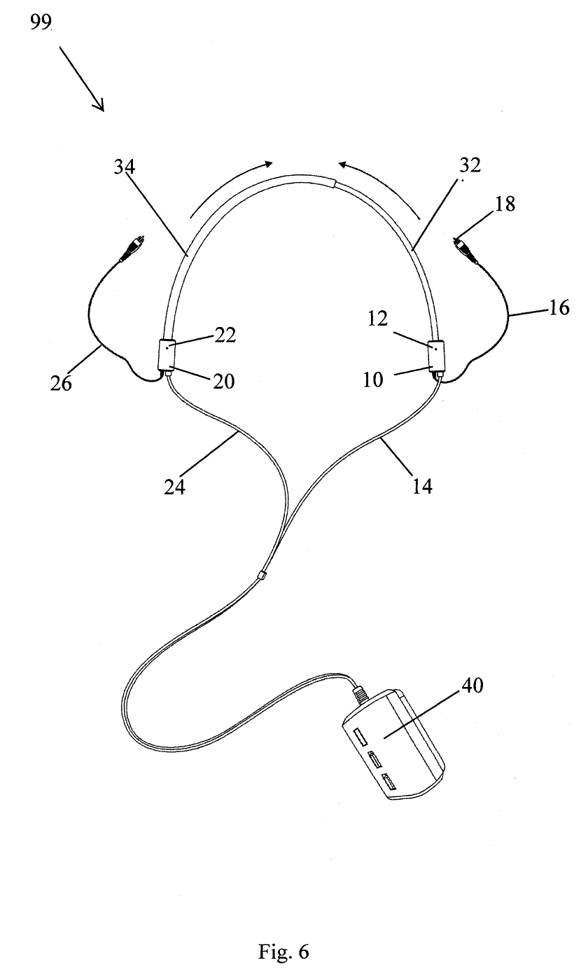

As shown in FIG. 6, in another embodiment, the two sub-portions 32, 34 are telescopic with respect to each other so that the size of the hearing kit 99 can be reduced by inserting the sub-portion 32 into the sub-portion 34. There may be more than two sub-portions to further reduce the size of the hearing kit 99.

As shown in FIG. 7, in another embodiment, the third portion may be a flexible cord 30A for resting on the neck of the user. The cord 30A spreads out on the user's shoulder and hangs down from the shoulder to maintain a sufficient distance of about 15 cm to 18 cm between the two microphones 12, 22 for a good beamforming result.

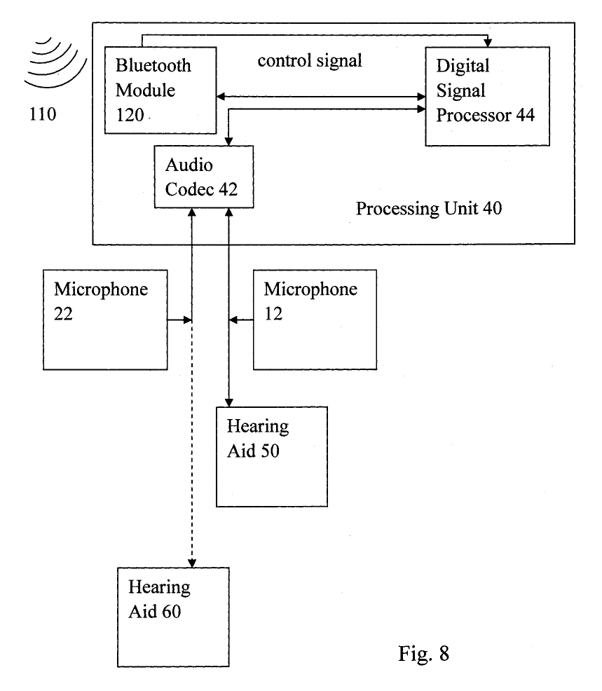

As shown in FIG. 8, in another embodiment, the processing unit 40 may also be used for receiving incoming calls from mobile phone and transmitting the signal to the hearing aid 50. In this embodiment, the processing unit 40 includes a Bluetooth module 120 for receiving wireless signal 110, for example, from mobile phone. The signal will be transmitted through the digital signal processor 44 to the audio codec 42 for converting into audio signal, and then be transmitted to the hearing aid 50. A control signal is also transmitted to the digital signal processor 44 when the Bluetooth module 120 receives the incoming signal 110 from the mobile phone.

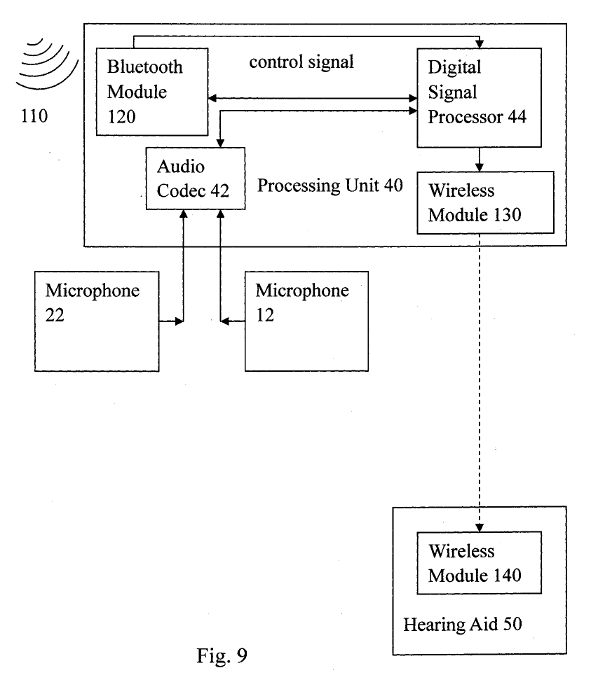

As shown in FIG. 9, in another embodiment, the third wire 16 in FIGS. 2a and 2b is replaced by wireless connection. The processing unit 40 includes a wireless module 130 for wirelessly transmitting the processed signal from the digital signal processor 44 to the hearing aid 50. The hearing aid 50 may come with a wireless module 140 for the reception of wireless signal. Otherwise, a wireless module 140 will have to be added on to the hearing add 50 for receiving the wireless signal from the processing unit 40. The wireless connection may apply, by non-limiting examples, Frequency Modulation (FM), Bluetooth or infra-red connection.

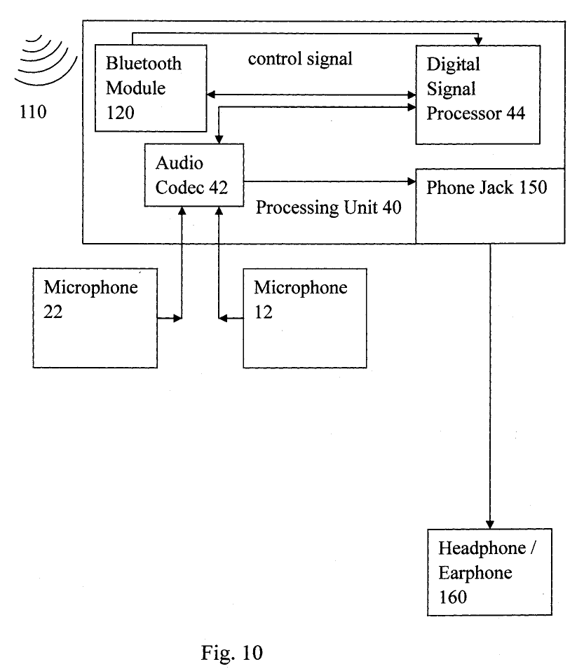

Some users may have only mild hearing problem and do not use a hearing aid. As shown in FIG. 10, in yet another embodiment, the processing unit 40 includes a phone jack 150 for transmitting the processed signal from the audio codec 42 directly to a hearing device, for example, a conventional headphone or earphone 160 of the user.

While the invention has been described in detail with reference to disclosed embodiments, various modifications within the scope of the invention will be apparent to those of ordinary skill in this technological field. It is to be appreciated that features described with respect to one embodiment typically may be applied to other embodiments.

What is claimed is:

1. A hearing kit for use with a hearing device applying fixed beamforming technology, comprising
a first end portion,
a first microphone disposed at the first end portion,
a second end portion,
a second microphone disposed at the second end portion,
an elongated third portion between the first and second end portions for resting on the user's neck, adapted to position the first and second microphones on the left and right sides of the user at the same level, wherein the first and second microphones are adapted to face outward toward the same direction in use, and
a processing unit adapted to process signals received from the microphones and transmit processed signals to the hearing device of the user,
whereby the microphones face toward the same direction of the user for receiving the listening sound.

2. The hearing kit as recited in claim 1, wherein the third portion is bended.

3. The hearing kit as recited in claim 1, wherein the third portion is flexible.

4. The hearing kit as recited in claim 1, wherein the third portion is a cord.

5. The hearing kit as recited in claim 1, wherein hearing kit further comprising a wire adapted to transmit the processed signals to the hearing device of the user.

6. The hearing kit as recited in claim 1, wherein the third portion is foldable for superimposing the first end portion with the second end portion.

7. The hearing kit as recited in claim 1, wherein the third portion further comprises
two sub-portions, each sub-portion having a rotatable end, and
a connecting member adapted to connect with the said ends, wherein each said end is rotatable on the connecting member to superimpose the sub-portions.

8. The hearing kit as recited in claim 1, wherein the third portion further comprises a plurality of telescopic sub-portions.

9. The hearing kit as recited in claim 5, further comprises another wire adapted to transmit the processed signals to another hearing device of the user.

10. The hearing kit as recited in claim 1, wherein the connection between the processing unit and the hearing device is wireless.

11. The hearing kit as recited in claim 1, further comprising a connection means for connecting the microphones with the processing unit.

12. The hearing kit as recited in claim 7, wherein the connecting member further comprising a stopper disposed adjacent to the end of the sub-portion to limit the rotation of the sub-portion.

13. A hearing kit for use with a hearing device applying fixed beamforming technology, comprising
a first end portion,
a first microphone disposed at the first end portion,
a second end portion,
a second microphone disposed at the second end portion,
an elongated third portion between the first and second end portions for resting on the user's neck, bended and adapted to position the first and second microphones on the left and right sides of the user at the same level, wherein the first and second microphones are adapted to face outward toward the same direction in use,
a processing unit adapted to process signals received from the microphones,
a connection means for connecting the microphones with the processing unit, and
a wire adapted to transmit the processed signals to the hearing device of the user,
whereby the microphones face toward the same direction of the user for receiving the listening sound.
